(19) United States
(12) Patent Application Publication
(10) Pub. No.: US 2023/0240275 A1
(43) Pub. Date: Aug. 3, 2023

(54) TOPWATER FISHING LURE WITH ROTATING PROPELLER AND STABLIZING FIN

(71) Applicant: Mystery Tackle Box, Inc., Chicago, IL (US)

(72) Inventors: Gabriel PRERO, Chicago, IL (US); Christopher John BULAW, Roselle, IL (US); Matthew Roy KESTUFSKIE, Chicago, IL (US)

(73) Assignee: Mystery Tackle Box, Inc., Chicago, IL (US)

(21) Appl. No.: 17/590,392

(22) Filed: Feb. 1, 2022

(51) Int. Cl. A01K 85/12; A01K 85/00

(52) U.S. Cl. CPC A01K 85/12; A01K 85/1837

(57) ABSTRACT

An improved topwater fishing lure with a rotating spinner element is disclosed that includes stabilizing fins along a rear tail portion to help balance the lure and prevent roll over and minimize other undesirable dynamics.

### BACKGROUND OF THE INVENTION

### Field of the Invention

The present disclosure is generally directed toward artificial fishing lures and more particularly to an improved topwater fishing lure with a rotating propeller having stabilizing fins that help the fishing lure remain level as it is cast and retrieved.

### Background

Fishing is one of the most popular outdoor recreational activities in the world, with an estimated 50 million Americans engaged in freshwater, saltwater, and fly-fishing activities annually. Fishing often involves using a bait, which may be natural or artificial, that is attached or otherwise coupled with one or more hooks and tied to a line that may be cast (e.g., using a rod and reel) out over a body of water (e.g., a lake, stream, or ocean) to attract a fish and elicit a strike. Once the fish strikes, the hook(s) coupled to the bait pierce into the tissue of the fish, typically in the fish's mouth, resulting in a hookset which allows the fish to be caught once the line is drawn in. The type of bait that is used will typically vary depending on the species of fish and the habitat or conditions in which it is being fished.

A fishing lure is a type of artificial fishing bait which is designed to attract or “lure” a fish to strike (e.g., using movement, vibration, flash and/or color to bait the fish). Fishing lures generally seek to emulate the appearance and/or movement of prey, but may also appeal to a fish's sense of territory, curiosity and/or aggression. Fishing lures, for example, may be designed to look like smaller prey, or may include features to attract fish as they are retrieved through or atop the water as the line is drawn in. Fishing lures, for instance, commonly include spinners or propellers positioned at the “tail” end of the lure that spin when reeled in, attracting fish through the motion of the lure and vibrations sent through the water.

Fishing lures that are intended to swim atop the water are often referred to as “topwater” lures. It is important that such topwater lures remain level as they are retrieved in order to elicit a fish strike, as unnatural and inconsistent lure action may make fish wary and hesitant to strike. Maintaining the level of the lure is also important to ensure that the fish hooks are fully exposed (i.e., hanging downward), which is ideal for hooking a fish. Conventional top water lures, however, are unable to maintain their balance during retrieval and will unpredictably wobble or roll over onto their side. The issue is particularly acute in topwater lures having a propeller or spinner, as such lures generate rotational dynamics that increase the likelihood of roll over and are typically retrieved with few or no deliberate pauses by the angler (i.e., constantly retrieved) making it unlikely that the lure will independently rebalance during retrieval. Furthermore, traditional methods of combatting roll over, namely by adding weight to the lure (e.g., along its bottom), are ill suited for use with topwater lures which are intended remain atop the water and not sink.

### BRIEF SUMMARY OF THE INVENTION

The present invention seeks to address the above-mentioned problems with traditional top water lures having a propeller or spinner element by providing an independent stabilizing fin on the lure body. The stabilizing fin allows the lure to land upright when cast and remain level during retrieval.

### BRIEF DESCRIPTION OF THE DRAWINGS

The accompanying drawings, which are incorporated herein and form part of the specification, illustrate one or more aspects of the present invention and, together with the description, further serve to explain the principles of the invention and to enable a person skilled in the relevant art(s) to make and use the invention.

FIG. 1 depicts a first side view of an exemplary embodiment of a fishing lure in accordance with the present invention.

FIG. 2 illustrates a second side view of the exemplary fishing lure.

FIG. 3 illustrates a back view of the exemplary fishing lure.

The features and advantages of the disclosed embodiments will become more apparent from the detailed description set forth below when taken in conjunction with the drawings. In the drawings, like reference numbers generally indicate identical, functionally similar, and/or structurally similar elements. Unless otherwise indicated, the drawings provided throughout the disclosure should not necessarily be interpreted as to-scale drawings.

### DETAILED DESCRIPTION

This specification discloses one or more embodiments that incorporate the features of this invention. The disclosed embodiment(s) merely exemplify the invention, and the scope of the invention is not thus limited. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

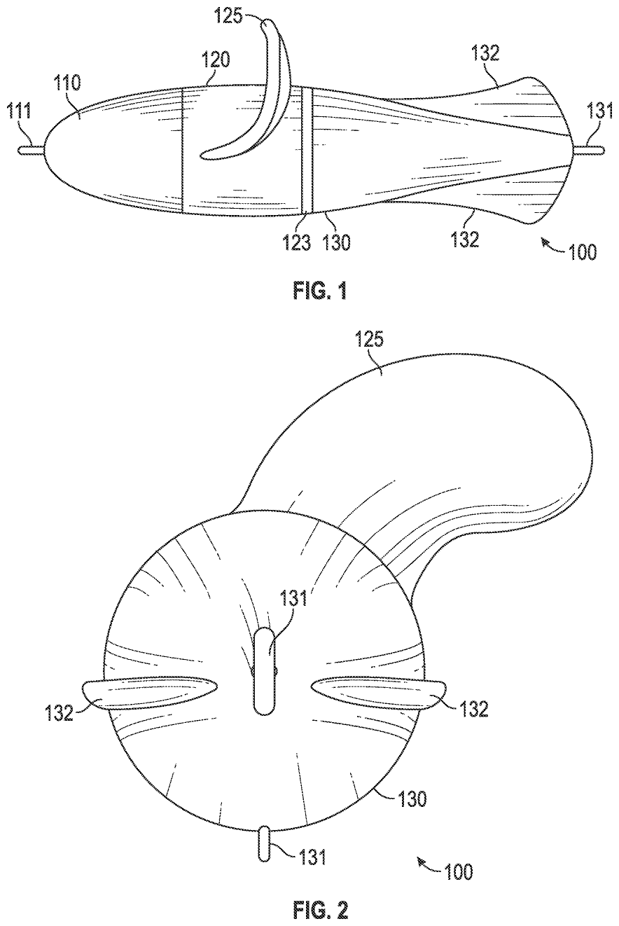

FIGS. 1-3 depict an exemplary embodiment of a topwater fishing lure 100 in accordance with the present invention. The fishing lure 100 may be a hollow hard bodied lure formed of plastic and may take on any number of shapes and sizes. The fishing lure 100, for example, may take the form of prey fish (e.g., rainbow smelt, gizzard shad, perch, blue gill, etc.) or other creatures (e.g., crabs, squid, worms, lizards, frogs, leeches, etc.) and objects suitable to attract a target fish. For instance, as illustrated, the fishing lure 100 is shaped like a shad, a common bait used for fishing Bass.

The fishing lure 100 may include a front head portion 110, a central trunk portion 120, and a rear tail portion 130, which may be formed or assembled together to form the fishing lure 100. As discussed further below, the central trunk portion 120, or a portion thereof, may act as a spinner or propeller that rotates as the fishing lure 100 is drawn in. The rear tail portion 130, in turn, may include one or more features to stabilize the fishing lure 100, which may help to balance the lure and prevent roll over and minimize other undesirable dynamics.

The front head portion 110 may be shaped like the head of a prey fish that the lure is seeking to emulate, and may include one or more characteristic features of the prey fish in order to do so. For example, the front head portion 110 may include eyes and gills, and may be shaped and colored to mimic the appearance of the prey fish. The front head portion 110, along with the central trunk portion 120 and rear tail portion 130, more generally may be colored or patterned in a particular manner to attract the target fish (e.g., to be bright and iridescent and/or realistically mimic a prey fish).

The front head portion 110 may also include a line tie 111 that may allow for the fishing lure 100 to be secured to a fishing line (not illustrated). The line tie 111 may be made of a light-weight plastic or metal and may consist of a tie body embedded within the front head portion 110 and an eye to which the fishing line may be secured (e.g., using a knot). The tie body may be used to secure the line tie 111 within the front head portion 110 and may operate to translate the forces applied by the fishing line to the fishing lure 100. The eye may be positioned at an end of the tie body and may extend beyond the front head portion 110 to permit securement of the fishing line thereto. The tie body may be threaded or textured (or include similar features) that allow for firm securement within the front head portion 110 of the fishing lure 100. The tie body may be oriented within the front head portion 110 such that the neutral orientation of the fishing lure 100 will generally be maintained upon retrieval of the fishing line. In this way, the fishing lure 100 may better emulate the natural movement of prey as the lure is retrieved, and more effectively attract the sought after fish.

The central trunk portion 120 may be shaped like the trunk of the prey fish (e.g., generally cylindrical in shape) and may be coupled to the front head portion 110 and rear tail portion 130. The central trunk portion 120 may also be configured to rotate or spin as the fishing lure 100 is drawn in, producing attractive stimuli to draw the attention of a target fish (e.g., generating a plopping sound, creating water disruption, or jittering of the fishing lure 100 itself). As illustrated in FIGS. 1-3, for example, the central trunk portion 120 may include a propeller fin 125 provided on its surface that may experience axial and transverse forces as the fishing lure 100 is drawn in causing the central trunk portion 120 to rotate about a central axis. Coupling of the central trunk portion 120 to the front head portion 110 and rear tail portion 130 may be accomplished by any suitable means that permit independent rotation of the central trunk portion 120 (or a portion thereof) relative to the front head portion 110 and rear tail portion 130. The central trunk portion 120, for example, may take the form of a bearing 122 that is free to rotate about a shaft 123 or the like that is secured to or integrally formed with front head portion 110 and rear tail portion 130.

The rear tail portion 130 may be coupled to the central trunk portion 120 and may be generally shaped like the tail of the prey fish (i.e., narrowing from the central trunk portion 120 toward its terminal end). The rear tail portion 130 may be provided with one or more hook ties 131 positioned at various locations on the rear tail portion 130. For example, as illustrated in FIGS. 1-3, hook ties may be located along the bottom and at the terminal end of the rear tail portion 130. The hook ties 131 may be made of a light-weight plastic or metal and may consist of a tie body embedded within the rear tail portion 130 and an eye to which various types of hooks may be secured (e.g., single hook, treble hook, etc.). The tie body may be used to secure the hook ties 131 within the rear tail portion 130 and may operate to translate the forces applied by a target fish to the fishing lure 100. The eye of the hook ties 131 may be positioned at an end of the tie body and may extend beyond the surface of the rear tail portion 130 to permit securement of a hook. The tie body may be threaded or textured (or include similar features) that allow for firm securement within the rear tail portion 130 of the fishing lure 100.

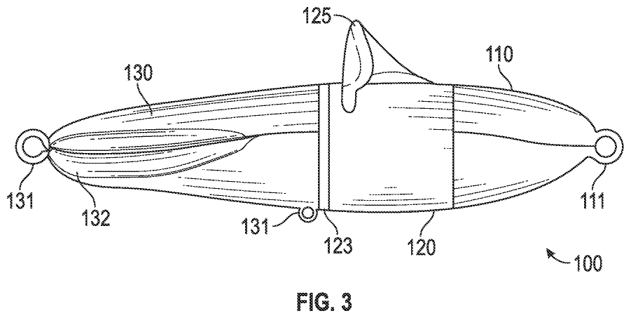

As discussed above, the rear tail portion 130 may also include one or more stabilizing features to help balance the lure and prevent roll over and minimize other undesirable dynamics. For example, as illustrated in FIGS. 1-3, the rear tail portion 130 of the fishing lure 100 may be provided with a pair of flattened rear tail fins 132 towards its distal end. In this way, the rear tail fins 132 may better support the surface water balance and weight distribution of the fishing lure 100, allowing the fishing lure 100 to land upright on the water when initially cast and remain level during retrieval. The rear tail fins 132 may be shaped to follow the contour of the rear tail portion 130 (e.g., along both its length and height) and may extend laterally outward, tapering in thickness as it does so. Furthermore, as illustrated in FIG. 3, the fins may be curved concave upward so as to provide a smooth transition point at the front and rear edge of the fin, minimizing turbulence with the water as the fishing lure is retrieved and allowing the fishing lure to glide, or skip, atop the water.

In some embodiments, the fishing lure 100 may also include one or more weighted portions that provide additional weight to the fishing lure 100. The weighted portion may be distributed within the fishing lure 100 in a particular manner, for example, generally disposed along the bottom of the front head portion 110 and/or rear tail portion 130, and may be shaped so as to conform to the profile of the fishing lure 100 (e.g., along the length and width of the respective portions). But because the fishing lure 100 is to be fished as a top water lure, the amount of weight that is added must be carefully determined (i.e., such that the fishing lure 100 will remain atop the water without sinking).

While specific embodiments of the invention have been described above, it will be appreciated that the invention may be practiced other than as described. For example, in alternate embodiments, the rear tail fin 132 of the fishing lure 100 may be placed at different locations along the fishing lure 100 (e.g., on the front head portion 110). In other embodiments, the fishing lure 100 may be provided with additional stabilizing features (e.g., additional stabilizing fins). As another example, while the fishing lure 100 of FIGS. 1-3 is formed of a front head portion 110, a central trunk portion 120, and a rear tail portion 130, the fishing lure 100 may be comprised of any number of portions or segments. In such cases, the fishing lure 100 may include multiple propeller or spinner portions, with different portions or segments rotating in opposite directions to minimize net rotational dynamics on the fishing lure 100 as a whole, or multiple portions having stabilizing features. More generally, the inclusion of stabilizing features is not limited to top water lures that include a spinner or propeller element, and the stabilizing features of the present invention may be included on any fixed portion of a fishing lure.

The description provided above is intended to be illustrative and non-limiting. Thus, it will be apparent to one skilled in the art that modifications may be made to the present invention as described without departing from the scope of the claims set out below. It is also worth noting that the Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A fishing lure comprising:
a front portion;
a central portion; and
a rear portion, wherein
the central portion is configured to rotate about a central axis, and
the rear portion comprises stabilizing fins to limit rotation of the fishing lure.

2. The fishing lure of claim 1, wherein the fishing lure is configured to float atop a water surface.

3. The fishing lure of claim 1, wherein the central portion is provided with a propeller fin that causes the central portion to rotate as the fishing lure is retrieved.

4. The fishing lure of claim 1 further comprising a weighted portion.

5. The fishing lure of claim 4, wherein the weighted portion is configured to distribute weight along the bottom of the front portion and shaped to conform to a profile of the front portion.

6. The fishing lure of claim 4, wherein the weighted portion is configured to distribute weight along the bottom of the rear portion and shaped to conform to a profile of the rear portion.

7. The fishing lure of claim 1, wherein the front portion, central portion, and rear portion, are formed of a hard plastic.

8. The fishing lure of claim 1, wherein the front portion is provided with additional stabilizing fins to limit rotation of the fishing lure.

9. The fishing lure of claim 1, wherein the stabilizing fins extend laterally outward.

10. The fishing lure of claim 1, wherein the stabilizing fins are curved concavely upward from a front edge of the stabilizing fins to a rear edge of the stabilizing fins.

11. A fishing lure comprising:
a plurality of portions including:
a fixed portion; and
a moving portion, wherein
the moving portion is configured to rotate about a central axis, and
the fixed portion comprises stabilizing fins to limit rotation of the fishing lure.

12. The fishing lure of claim 11, wherein the fishing lure is configured to float atop a water surface.

13. The fishing lure of claim 11, wherein the moving portion is provided with a propeller fin that causes the moving portion to rotate as the fishing lure is retrieved.

14. The fishing lure of claim 11 further comprising a weighted portion.

15. The fishing lure of claim 14, wherein the weighted portion is configured to distribute weight along the bottom of the front portion and shaped to conform to a profile of the front portion.

16. The fishing lure of claim 14, wherein the weighted portion is configured to distribute weight along the bottom of the rear portion and shaped to conform to a profile of the rear portion.

17. The fishing lure of claim 11, wherein the plurality of portions are formed of a hard plastic.

18. The fishing lure of claim 11, wherein the plurality of portions comprises another fixed portion that is provided with additional stabilizing fins to limit rotation of the fishing lure.

19. The fishing lure of claim 11, wherein the stabilizing fins extend laterally outward.

20. The fishing lure of claim 11, wherein the stabilizing fins are curved concavely upward from a front edge of the stabilizing fins to a rear edge of the stabilizing fins.
